(19) United States
(12) Patent Application Publication
(10) Pub. No.: US 2013/0055128 A1
(43) Pub. Date: Feb. 28, 2013

(54) SYSTEM AND METHOD FOR SCHEDULING POSTS ON A WEB SITE

(71) Applicants: Alessandro Muti, Mercer Island, WA (US); Leigh Fatzinger, Seattle, WA (US)

(72) Inventors: Alessandro Muti, Mercer Island, WA (US); Leigh Fatzinger, Seattle, WA (US)

(21) Appl. No.: 13/223,055

(22) Filed: Aug. 31, 2011

(51) Int. Cl. G06F 3/048

(52) U.S. Cl. 715/769

(57) ABSTRACT

A method and system for composing and posting content at a site on a wide area network includes receiving content for a proposed post. The system displays the content as a graphic tile. The graphic tile includes: a block displaying textual content within a nascent post; a status block displaying a status of review where the nascent post must be reviewed for release by at least one reviewing authority; and a block indicating the presence and identity of a MIME-type attachment within the nascent post. The system also displays a calendar window including a plurality of time slots corresponding to each of a plurality of posting times of the nascent post on the site. Scheduling the post of the nascent post on the site at a time requested is effected by “dragging and dropping” the graphic tile onto a time slot.

### FIELD OF THE INVENTION

The invention includes a system and method for posting content on a site on a Wide Area Network, specifically, for scheduled posting of content for optimizing a response in a community following the site.

### BACKGROUND OF THE INVENTION

Social media websites or portals, such as Facebook™, Twitter™, LinkedIn™, MySpace™, Buzz™, and others have become markedly popular in the hances of their users and because of that popularity, marketers and advertisers have sought means of exploiting the potential of these channels for different types of marketing and advertising. Marketers can post messages or advertisements on these social media systems as a way to advertise outside of traditional marketing channels, making more direct the process of getting information into the hands of the subscribers or members of each of the services.

Once a message or advertisement is in the hands of the various members, those members may, in turn, respond by clicking on embedded URLs (uniform resource locators), replying to the messages, starting posts based on the messages, or performing other site-specific functions. Over time, the results of such postings can be tracked and, by analysis techniques, the effectiveness of the postings can be measured.

Currently, a number of services exist to determine the impact of such messages. A first group is known as “Listening Platforms” and includes such as Radian6™, Visible Technologies™, Crimson Hexagon™, Alterian™, Sysmos™, Nielsen BuzzMetrics™. A second group having distinct methods is the “Content Publishing” group which includes HootSuite™, CoTweet™, Vitrue™, Awareness™, Involver™. A third group measures impact by still further distinct methods and will be collectively known as the “Reporting & Metrics” group which includes: Webtrends™, Omniture™, RowFeeder™ Twitalyzer™, and bit.ly™. Finally, there is the group known as “Social Media Applications” which includes Involver™, Buddy Media™, Wildfire Apps™, and AppBistro™. Without here commenting on the efficacy of each of these metrics suppliers, it is sufficient for purposes of this application to assert that there does exist at least one means of evaluating the impact of any posting and that those means are in real or near real time. In this application, those means will be represented by a block in both of the method and the system, indicating statistical analysis occurs. This application does not endeavor to teach any method of statistical analysis but rather, presumes its existence in order to achieve the method and system here taught. Nothing in this application requires the knowledge of these statistical means other than to presume their existence and that such statistical means can provide analysis in near real time.

Thus, given the ability to measure response to particular postings, one can readily understand that each post has a duration over which the positive interactions with a particular page on which the posting occurs will tend to also be positive. In a simplest example, one positive posting on a page evokes one positive response, agreeing and, maybe, amplifying the response. More typical, of course, given the traffic that most pages for which marketing might be considered, one shake of the tree generally drops a large number of responses or fruit. Statistics have shown the characteristic curve to be very much like that of a damped oscillating system decaying over time to zero. Given that characteristic curve, optimally exploiting a single post to keep the positive responses continuing until a threshold of decay that can be predicted by statistical analysis. Naturally, an optimum schedule can be derived from the statistical analysis and because of that fact, an optimal scheduling of produced postings becomes highly desirable.

There, currently, exists no optimal system or method to dynamically schedule postings on social media to engender the most positive responses over the longest duration. Suitable staging and production of such postings would allow precisely timed injection of additional postings just as the decay of engendered reactions decays to a selected threshold.

### SUMMARY OF THE INVENTION

A method and system for composing and posting content at a site on a wide area network includes receiving content for a proposed post. The system displays the content as a graphic tile. The graphic tile includes: a block displaying textual content within a nascent post; a status block displaying a status of review where the nascent post must be reviewed for release by at least one reviewing authority; and a block indicating the presence and identity of a MIME-type attachment within the nascent post. The system also displays a calendar window including a plurality of time slots corresponding to each of a plurality of posting times of the nascent post on the site. Scheduling the post of the nascent post on the site at a time requested is effected by “dragging and dropping” the graphic tile onto a time slot.

### BRIEF DESCRIPTION OF THE DRAWINGS

Preferred and alternative examples of the present invention are described in detail below with reference to the following drawings:

FIG. 1 is a block diagram of a computer system to facilitate the optimally scheduled posting of content on a site on a wide area network;

FIG. 2 is a composite diagram to indicate application of analytic methods to responsive posting on the site;

FIG. 3 is a graphic description of the method of polynomial approximation of responsive postings on the site;

FIG. 4 is an exemplary wire diagram of a graphic tile used to represent content of a post on the site;

FIG. 5 is an exemplary wire diagram of a graphic tile used to represent a summary of analysis of postings responsive to the initial post;

FIG. 6 is a screen shot of the inventive interface in an exemplary state;

FIG. 7 is an exemplary wire diagram of two distinct uses of the inventive interface;

FIG. 8 is a confirmatory screen indicative of the scheduling of a posting on the site;

FIG. 9 is a confirmatory screen indicative of the de-scheduling of a posting on the site;

FIG. 10 is an exemplary “month view” screenshot of the scheduling interface; and

FIG. 11 is an exemplary “week view” of the scheduling interface.

### DETAILED DESCRIPTION OF THE PREFERRED EMBODIMENT

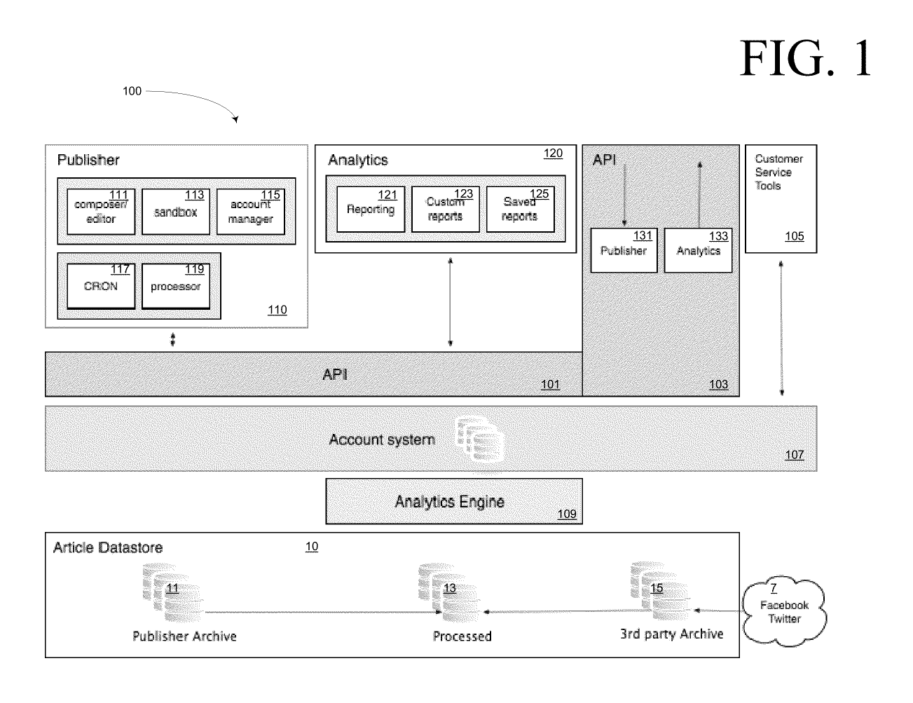

FIG. 1 depicts by block diagram an exemplary computing system that may be used to practice embodiments of a dynamically scheduled posting system described herein. Note that a general purpose or a special purpose computing system suitably instructed may be used to implement the method and system described herein. Further, the system and method may be implemented in software, hardware, firmware, or in some combination to achieve the capabilities described herein.

The computing system 100 may comprise one or more server or client computing systems and may span distributed locations; indeed, in its presently preferred embodiment, the system may be practiced across a number of platforms such that smartphones, tablets, and laptops will function as clients in a “cloud-based” environment. One virtue of the system as described, includes the simple and comprehensive nature of the interface, small screened client machines will readily afford a user the ability to fully control the computing system's composing, posting, and scheduling functions without losing any of the system's functionality.

In addition to the fact that any one block might be embodied in either of software or hardware, each block shown may, in one or more embodiments, represent one or more such blocks as appropriate to a specific embodiment or may be combined with other blocks. Moreover, the various blocks of the system 100 may physically reside on one or more machines, which use standard (e.g., TCP/IP) or proprietary interprocess communication mechanisms to communicate with each other.

In the embodiment shown, computer system 100 also comprises at least a computer memory (“memory”), a display (while not necessarily on the same computer system 100—it is envisioned that “headless servers” are a likely embodiment), one or more Central Processing Units (“CPU”), Input/Output devices (e.g., keyboard, mouse, CRT or LCD display, etc.), other computer-readable media, and one or more network connections (all of these features being within the common experience of one skilled in the art, the applicant believes this reference sufficiently explicit to explain facility for user interaction with the system and further explanation of the functionality is not necessary).

The elements of the system are depicted in FIG. 1 as existing in memory but more likely exist in several memories in a distributed network; and while application programming interfaces (APIs) are made explicit within the block diagram (e.g. 101, 103), many others may be implicit in the arrangement of elements within any particular embodiment. An API is a particular set of rules and specifications that software programs can follow to communicate with each other. It serves as an interface between different software programs and facilitates their interaction, similar to the way the user interface facilitates interaction between humans and computers.

An API can be created for applications, libraries, operating systems, etc., as a way of defining their “vocabularies” and resources request conventions (e.g. function-calling conventions). It may include specifications for routines, data structures, object classes, and protocols used to communicate between the consumer program and the implementer program of the API.

In other embodiments, some portion of the contents, some of, or all of the components of the computer system 100 may be stored on or transmitted over the other computer-readable media. The components of the computer system 100 preferably execute on one or more CPUs and manage the generation, promulgation, and use of postings, as described herein. Other code or programs and potentially other data repositories may also reside in the memory, and preferably execute on one or more CPUs. Of note, one or more of the components in FIG. 1 may not be present in any specific implementation. For example, some embodiments embedded in other software may not provide means for user input or display.

The first premise of the system 100 exists outside of the actual system, it is the social media 7 itself, and information that can be “scraped” therefrom. At any moment, a social medium 7 such as Facebook™ exists in a state that is generally observable on the Internet. What is made available on the social medium from minute to minute is a vast datastore that is observable and storeable in an archive such as that depicted at block 15. Information can be readily “mined” from the data and stored in a second datastore 13 where analytics might be used to track further reactions to posts that occur on the social medium 7.

By way of enabling example, consider a little-known unit of the U.S. Department of Energy, the Pacific Northwest National Laboratory (PNNL) division of the Center for Adaptive Supercomputing Software Multithreaded Architectures (CASS-MT). By way of explanation, the PNNL Task Lead, Rob Farber, explains his mission thus: “Social media has been identified as a valuable information source, providing analytic opportunities to discover emerging trends and denied or minority viewpoints. With such a massive data source, the problem of selecting relevant information is exacerbated by the size and complexity of the representative graphs. While the XMT can run massively multithreaded graph algorithms, it is also imperative that we harness both algorithms and machines to deliver validated results in forms understandable by people.”

“Our hypothesis is that complex data from online communities (known as weblogs, blogs, or microblogs) can be condensed into descriptions that—despite their terseness—still provide useful insight into the nature of the online communities.

“The PNNL team has leveraged the observation that posts in online social communities follow a power law distribution, which implies that a few authors or information sources have a disproportionately large influence on an online community. Our key insight that a few of these high agency information sources drive (and potentially control) discourse and the information conveyed within the online community. Our methods separate out these key agents from those that participant in “flame wars” where responses tend to be of a personal nature, “echo chambers” where comments tend to reaffirm a commonly held opinions or positions, and information relays that merely repeat information provided by others.

“Determining the most influential users of Twitter is probably not what the creators of the Cray XMT supercomputer had in mind when they designed their machine. But when you're packing this much computational heat, you go where the hard problems are. Twitter, Facebook and the rest of the social Web have become the modern-day equivalent of the water cooler, albeit with an automatic transcriptionist present. And processing all the data that conversation generates turns out to be a very hard problem.

“For example, as of February 2010, Facebook included 400 million active users with an average of 120 ‘friend’ connections each; all of whom collectively shared 5 billion pieces of information in a single month.

“Figuring out who the “influencers” are in such a massive social networks requires creating a gigantic social graph, where each user is a vertex and the connections between them are lines. Ranking users within such a graph requires a determination of their “centrality”. That is, how many other people are connected to them, and how many people are connected to them, and so on, until you get to the trunk of the tree structure underlying connectedness on a service like Twitter.

“It turns out this is not the sort of problem that is readily handled even by the usual go-to workstations of the scientific supercomputing world—the GPGPU-powered supercomputers that leverage the graphics chips usually used to render lush 3D environments in videogames. These GPGPU workstations simply don't allow enough control over how many processes are running in parallel to efficiently churn through social graphs as big as the one represented by Twitter or Facebook.

“That's why David Ediger of Georgia Tech, with the help of a long list of collaborators, turned to the 128-CPU Cray XMT housed at the Pacific Northwest National Laboratory. The XMT is a favorite of supercomputing hot-rodders and uber-geeks who appreciate its fine-grained massively multithreaded tunability. This machine is usually pressed into service for solving problems like “Hierarchical Bayesian Modeling for Text Analysis” or analyzing the stability of America's power grid, but Ediger had it cogitating on every stray thought from a single day's worth of the Twitter firehose.

“The Cray made short work of Twitter, disposing of an entire day's worth of connections in under an hour. The results will surprise no one—on Twitter, a tiny fraction of sources are retweeted widely, mostly government and media, while the rest of the service is either people talking in small groups or literally talking to themselves.

“The point, though, is that throwing a finely-tuned Cray running Ediger's custom software—GraphCT—at Twitter allowed the researchers to digest the service in something like real time. Which is exactly the sort of capability that intelligence agencies, marketers and, perhaps, even Twitter itself might want to have.

“Scraping social media from a variety of sources (blogs, microblogs, Twitter, etc.), we target online communities and posts through keyword searches. We then generate graphs where each node is an author and every edge represents either a post or comment. Agents of interest (e.g thought-leaders or information-leaders) are identified by triangulating across to several metrics based on centrality of the nodes. High-ranking low-frequency nodes (as implied by the power law) can be separated from huge amounts of data and presented to the analyst for further analysis.”

While the whole of the social medium 7 can be stored at the third party archive 15 analyzed, and the results of the analysis stored at a datastore 13, it is also possible to perform the same sort of analysis on a very limited subset of the whole of the social medium 7 but, rather, on the results of a single publisher's posts on the publisher's own pages. Naturally, as compared to taking in the whole scope of the medium 7, studying a selected subset is nearly trivial in comparison. No single source of postings on the medium 7 can even amount to a significant fraction of the five billion pieces of information that are posted in a month. Thus, enablement of analysis of the whole of the medium 7 amounts to enablement of the microportion of the medium 7 that consists of a publisher's own postings stored in a publisher archive 11.

From the collected processed information stored at the datastore 13, an analytics engine such as the Cray XMT, or many lesser computers running an analytic suite such as GraphCT can readily produce meaningful information within the Analytics Engine 109 and that engine 109 serves to inform the system 100 as to the trending, curves that represent growth and decay of responsive tweets and posts that a particular post has engendered. This analytic engine 109 enables the ascertainment of an expected profile for any given post and further enables the dynamic reprofiling of that same growth and decay for the given post as more information is made available to the engine 109.

In moving from the whole of the social medium 7 to particular instances thereof, this explanation presumes the existence of customer who purchase, as a service, the tracking of their posts, the publication of the customer's posts, and the scheduling thereof. To accomplish these services, the system 100 includes an account system 107 along with an interface including customer service tools 105 provided the customer to allow management of accounts and to provide the system 100 with active accounts. The customer service tools 105 are, in one presently preferred embodiment, enabled by a web portal Relative to the inventive systems, these tools and accounting are relatively conventional and serve primarily to identify targets for the services provided in the Publisher 110, the Analytics 120 and their respective portals, the Publisher portal 131, and the Analytics portal 133 to the Internet and to the Analytics Engine 109.

For purposes of the prosecution of a nascent post to posting on a social medium 7, the Publisher 110 is an exemplary method of placing a post on a selected site; references to “Publisher” 110 might be equally valid using some other publishing application or script, but for purposes of illustration “Publisher” is an internal script as pictured in FIG. 1. (The term nascent post is coined herein to describe the product of a post author which is configured to be a post on a social medium 7 but has not yet been posted to that social medium 7. In that sense, nascent conveys the potential to be a post without the actual posting. Thus, a nascent post is contrasted to a post only in its actual appearance on the social medium 7.) The Publisher 110 comprises a Composer/Editor 111, a Sandbox 113 and an Account Manager 115 to create a nascent post as well as a Scheduler (CRON-use of the term Cron as labeled here is not intended as limiting and system time might be kept in any fashion suitable for distributed computing) 117 and a Processor 119 to perform analysis on the actual selected words of the nascent post such as lexical processing such as grammar, spelling, word selection and syntax (indeed, the Processor 119 is, optionally, the source of the voice of the putative author, for example by using word selection to differentiate based upon demographic data between those in a post to appeal to adolescent white females from those in a post to appeal to mature black professionals.) The Publisher 110 comprises these distinct roles to optimize the content and timing of a post relative to the product and a target demographic.

Parenthetically, the term “sandbox” is used to be a staging area for nascent posts. The concept of the sandbox (the term here is used interchangeably with the term “staging area”) allows revision control within the defined environment, optionally subject to a reviewing authority's review and revision. The presence of the sandbox 113 facilitates review to prevent the unintended release of information or expressions of opinion that might damage the user or user's client. By defining a sandbox 113, the application assures that the nascent post is ready for release when its release is scheduled. Only after the reviewing authority has (hopefully) fully vetted the release in the sandbox 113 should the reviewing authority schedule the release of the nascent post to become an actual posting on the site.

Persons having distinct roles contribute to formation of a nascent post. To suitably limit their contributions, an Account Manager 115 is used to define access to a page or pages assigned to an account. Access is the ability to do something with a computer resource (e.g., use, change, or view), in this case a nascent post. Access control is the means by which the ability is explicitly enabled or restricted in some way (usually through physical and system-based controls). Computer-based access controls can prescribe not only who or what process may have access to a specific system resource, but also the type of access that is permitted. These controls may be implemented in the computer system or in external devices.

In the preferred embodiment of the invention, a role based access control is used to allow a prolixity by product, thereby allowing many more authors to contribute to posts while narrowing the controlling decision makers to those with knowledge of the product itself With role-based access control (“RBAC”), access decisions are based on the roles that individual users have as part of an organization. In the currently preferred embodiment, RBAC allows suitable narrowing of access but the inventive nature is not dependent upon the use of RBAC over other conventional means of limiting access to full function of the system.

Access rights are grouped by role name, and the use of resources is restricted to individuals authorized to assume the associated role. For example, within a the system 100, there may be, as distinct roles, an author who writes the nascent release, a releaser who has authority to actually order the posting of a nascent post on the page, and a manager who has the authority to assign persons to the roles. The role of releaser can include drafting the nascent post, receiving lexical guidance as to the post, receiving scheduling guidance as to the nascent post, and to perform actual release decision according to a scheduled posting time, the nascent post; and the role of author can be limited to gathering information to propose a nascent post.

Under RBAC, roles can have overlapping responsibilities and privileges; that is, users belonging to different roles may need to perform common operations. Some general operations may be performed by all employees. In this situation, it would be inefficient and administratively cumbersome to specify repeatedly these general operations for each role that gets created. Role hierarchies can be established to provide for the natural structure of an enterprise. A role hierarchy defines roles that have unique attributes and that may contain other roles; that is, one role may implicitly include the operations that are associated with another role.

Role hierarchies are a natural way of organizing roles to reflect authority, responsibility, and competency. Importantly, roles are defined relative to the subject of a destination page, generally, though not exclusively, these roles are defined by a product within a product line offered by a customer who owns the page. Thus, relative to any product line, the role in which the user is gaining membership is not mutually exclusive with another role for which the user already possesses membership. These operations and roles can be subject to organizational policies or constraints. When operations overlap, hierarchies of roles can be established. Instead of instituting costly auditing to monitor access, organizations can put constraints on access through RBAC. For example, it may seem sufficient to allow a releaser relative to one product within a product line to have access to all nascent posts within the product line if their access is monitored carefully. With RBAC, constraints can be placed on releaser access so that only those records that are associated with a particular product within the line can be accessed.

Customers can establish the rules for the association of operations with roles. For example, a manager may decide that the role of releaser must be constrained to post only the nascent posts relative to certain products within the line but not to distribute them where routing and human errors could cause redundant posts as to other products. Operations can also be specified in a manner that can be used in the demonstration and enforcement of laws or regulations. For example, a releaser can be provided with operations to release as to one product, but only as an author relative to another product in the line.

An operation represents a unit of control that can be referenced by an individual role, subject to regulatory constraints within the RBAC framework. An operation can be used to capture complex security-relevant details or constraints that cannot be determined by a simple mode of access.

The RBAC framework provides administrators with the capability to regulate who can perform what actions, when, from where, in what order, and in some cases under what relational circumstances. Thus, only those operations that need to be performed by members of a role are granted to the role. Granting of user membership to roles can be limited. Some roles can only be occupied by a certain number of employees at any given period of time. The role of manager, for example, relative to a product or line can be granted to only one employee at a time. Although an employee other than the manager may act in that role, only one person may assume the responsibilities of a manager at any given time. A user can become a new member of a role as long as the number of members allowed for the role is not exceeded.

A properly-administered RBAC system enables users to carry out a broad range of authorized operations, and provides great flexibility and breadth of application. System administrators can control access at a level of abstraction that is natural to the way that enterprises typically conduct business. This is achieved by statically and dynamically regulating users' actions through the establishment and definition of roles, role hierarchies, relationships, and constraints. Thus, once an RBAC framework is established for an organization, the principal administrative actions are the granting and revoking of users into and out of roles. This is in contrast to the more conventional and less intuitive process of attempting to administer lower-level access control mechanisms directly (e.g., access control lists [ACLs], capabilities, or type enforcement entities) on an object-by-object basis. For this reason, an account manager 115 is used to enforce access according to roles relative to a product.

Assuming, now, that the Account Manager 115 enforces a definition of the roles and access relative to the roles, the Composer/Editor becomes the relevant component for actual composition of the nascent post. As with all of the described components, it bears stating, however, that components or modules of the system 100 are implemented using standard programming techniques. However, a range of programming languages known in the art may be employed for implementing such example embodiments, including representative implementations of various programming language paradigms, including but not limited to, object-oriented (e.g., Java, C++, C#, Smalltalk, etc.), functional (e.g., ML, Lisp, Scheme, etc.), procedural (e.g., C, Pascal, Ada, Modula, etc.), scripting (e.g., Perl, Ruby, Python, JavaScript, VBScript, etc.), declarative (e.g., SQL, Prolog, etc.), etc.

As is stated above, the seams between the various applications, the APIs, may also use well-known or proprietary synchronous or asynchronous client-server computing techniques. However, the various components may be implemented using more monolithic programming techniques as well, for example, as an executable running on a single CPU computer system, or alternately decomposed using a variety of structuring techniques known in the art, including but not limited to, multiprogramming, multithreading, client-server, or peer-to-peer, running on one or more computer systems each having one or more CPUs. Some embodiments are illustrated as executing concurrently and asynchronously and communicating using message passing techniques. Equivalent synchronous embodiments are also supported by a system implementation.

In addition, programming interfaces to the data stored as part of the system 10 (e.g., in the data repositories 11, 13, and 15) can be available by standard means such as through C, C++, C#, and Java APIs; libraries for accessing files, databases, or other data repositories; through scripting languages such as XML; or through Web servers, FTP servers, or other types of servers providing access to stored data. Thus, any component such as the Composer/Editor 111 may be implemented as one or more database systems, file systems, or any other method known in the art for storing such information, or any combination of the above, including implementation using distributed computing techniques. And, again, the system 100 may be implemented in a distributed environment comprising multiple, even heterogeneous, computer systems and networks. Also, one or more of the modules may themselves be distributed, pooled or otherwise grouped, such as for load balancing, reliability or security reasons. Different configurations and locations of programs and data are contemplated for use with techniques of described herein. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, etc.) etc. Other variations are possible. Also, other functionality could be provided by each component/module, or existing functionality could be distributed amongst the components/modules in different ways, yet still achieve the functions of the system 100.

Furthermore, in some embodiments, some or all of the components of the system 100 may be implemented or provided in other manners, such as at least partially in firmware and/or hardware, including, but not limited to one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the system components and/or data structures may also be stored (e.g., as executable or other machine readable software instructions or structured data) on a computer-readable medium (e.g., a hard disk; a memory; a network; or a portable media article to be read by an appropriate drive or via an appropriate connection). For example, a distinct handheld device might include all of the Sandbox 113 functionality and may, optionally, be given to a releaser on the eve of a new product release to allow decisions to be made at any time appropriate therefor. For that reason, no limitation as to platform or software is intended by the enabling discussion.

The above discussion applies with the greatest vigor to the Composer/Editor 111, wherein it is envisioned that in at least one embodiment, the “cut and paste” function of the Windows™ interface might be used to allow an author to compose a nascent post within a word processor such as Word™ as part of a series of nascent posts and, then, to drop them into a web-based portal as distinct nascent posts for review by a releasing authority. In alternate embodiments, the word processing is in a client application on any of a tablet, smartphone, or computer; an Active Server Page; a Short Message Service (SMS) or Enhanced Message Service (EMS) application; or other means of delivering text an content to an API for incorporation into a nascent message. For the purposes of this non-limiting exemplary discussion of the system 100, nascent posts originate in the Composer/Editor 111. In some embodiments, the Composer/Editor 111 includes a buffer to allow the import of textual content without a distinct word processor being included in the system. In other embodiments, the Composer/Editor 111 is configured include a WYSIWYG editor facility as is often used in an HTML composition software.

Once a nascent post exists, it is transferred to the Sandbox 113 for its further progress on its trip to becoming a post. The Sandbox 113 is the component for the execution of decisions relating to whether and when a nascent post will be scheduled for publication as a post. The Sandbox is also the place, by means of the below-described interface, where the propriety of scheduling based upon the CRON 117 component and the Processor 119 component are displayed to the releaser. Once a nascent post leaves the Composer/Editor 111, the Sandbox 113 receives the nascent post in a buffer and while the nascent post resides in the buffer, the Processor 119 reviews its content relative to lexical patterns it contains, the target demographic, and the product being described. As will be shown in greater detail in the discussion of the inventive interface relative the remaining figures, the information derived from the lexical analysis is displayed along with the nascent post. Naturally, the lexical processing includes the removal of inappropriate language, judge inappropriate because of the target demographic or simply because of the nature of the language is simply not wisely chosen. Instances of inappropriate language might include the use of a competitor's product name, reference to persons who have not given permission for the use of their name or likeness, or, in its simplest form, slang or other expressions that are not consistent with the image of the product.

The Analytics 120 are the basis of developing polynomial characteristic curves that inform the process by predicting, dynamically the responses from a given nascent post as it progresses to post and further. As indicated above, the datastore 13 is collected and analytics are applied to develop a library of characteristic curves.

Also as stated above, the library of curves is associated with relevant data, for example, the occurrence of words or phrases, the subject matter of the post, the apparent voice of the author of the post, the apparent gender of the author, the presence of advice relating to a product, the presence of statistical data regarding the product, and the endorsement or comments by a known celebrity. The curves are stored in families that, through statistical analysis to be representative of the decay associated with posts were made in an environment and at a time when the decay might have been affected by an even such as a sports event or a political convention. Thus, for example, during the Winter Olympics, activity generated by a post relating to K2™ skis might be predictably suppressed during the Giant Slalom event. Such curves are stored, by way of non-limiting example, as polynomials.

A polynomial function is one that has the form:

γ=αₙxⁿ+αₙ₋₁xⁿ⁻¹+αₙ₋₂xⁿ⁻²+. . . +α₀

with n denoting a non-negative integer that defines the degree of the polynomial. A polynomial with a degree of 0 is simply a constant, with a degree of 1 is a line, with a degree of 2 is a quadratic, with a degree of 3 is a cubic, and so on.

Historically, polynomial models are among the most frequently used empirical models for fitting functions. These models are popular for the following reasons:
Polynomial models have a simple form.
Polynomial models have well known and understood properties.
Polynomial models have moderate flexibility of shapes.
Polynomial models are a closed family. Changes of location and scale in the raw data result in a polynomial model being mapped to a polynomial model. That is, polynomial models are not dependent on the underlying metric, such that where what is influencing a response might not be known with specificity; it is still possible to perform an estimate that will be numerically accurate within a range.
Polynomial models are computationally easy to use.

Because of the ability to constantly observe postings on one's own page, iterative statistical comparison to families of curves stored in the library is possible on a dynamic basis, i.e. a “best fit” is continually reconfigured to converge on a “most predictive” curve such that as the number of responsive posts accumulate after an initial post, the predictive curve more closely resembles the actual numbers and timing of responsive posts after a subject post because of further iterations. When so generated, it is possible to determine when to inject a “next” post onto the site to continue to optimize responsive emails. Naturally, as shown, the Analytics 120 section has the ability to generate reports in accord with standardized templates at the report generator 121, in accord with customized templates at a customized report generator 123 and to store such reports as are helpful in a report database 125.

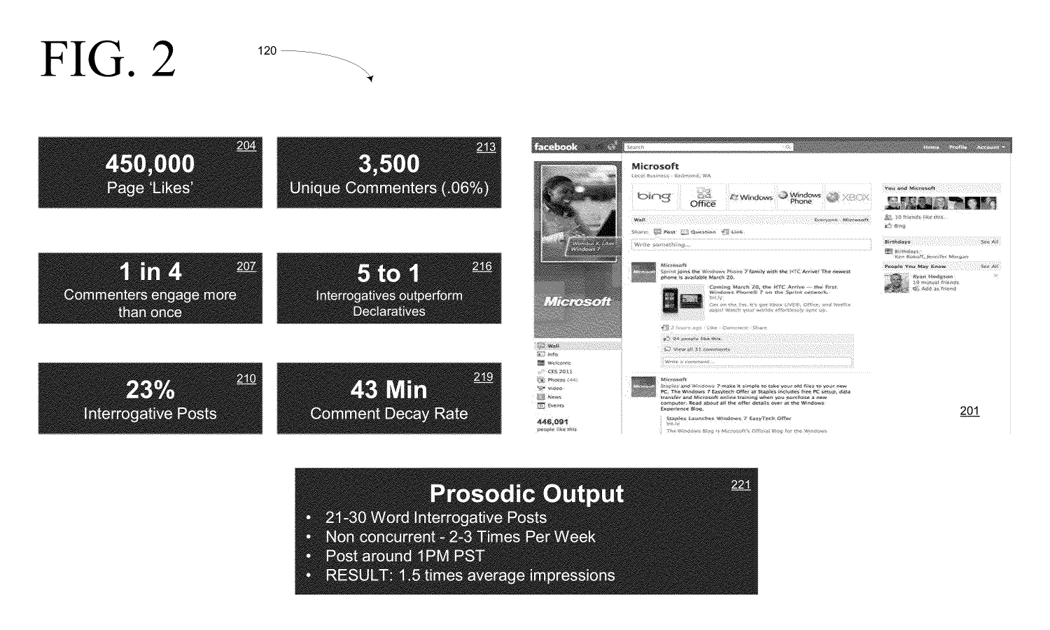

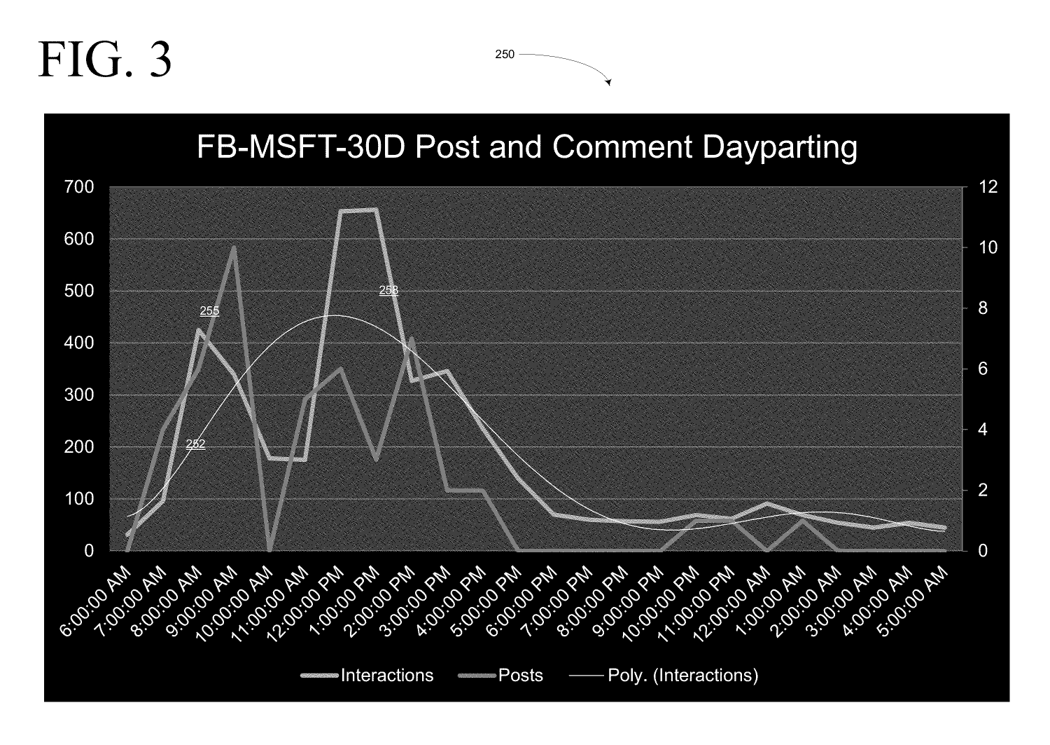

The Analytics 120 section and the reports it generates can be much better understood in the context of a nonlimiting example such as that depicted in FIGS. 2 and 3. The Analytics contains records of any of a number of target sites whose ownership has granted rights. One exemplary site 201 includes a studied post and then the accumulated information. Since its posting, the site's page scored 450,000 “Likes” as is reported at a block 204 in the report. The Like button lets a user share content on the exemplary page with friends on Facebook. When the user clicks the Like button on the exemplary site, a story appears in the user's friends' News Feed with a link back to the exemplary website. By this mechanism, the exemplary page will appear in the “Likes and Interests” section of the user's profile, and the owner of the site, thereby, has the ability to publish updates to the user. By such a means, the owner of the site can target ads to people who like the owner's content. Where successful, the number of likes, in this case, 450,000 represents 450,000 placements of an advertisement equivalent in the hands of 450,000 interested potential purchasers. The targeted nature of these advertisements makes each of them very valuable and that value, when multiplied by the 450,000 in volume means that the placement of that single post, costing nothing in publication costs, might yield a finite but large number of sales or other actions that the placement was meant to foster.

These placements offer several different measurable parameters. Naturally, “likes” as defined above are very valuable but these are just one of the possible actions that would be useful. An “action” can be any action that responds to a post such as a reply, a forwarding (in Twitter™ terms, a retweet), a comment, or a click. Each of these amounts to a republication of the posting with generally positive responses. Studies have shown that persons are far more likely to respond positively than negatively to posts—people want to identify themselves with successful products or services much more than they want to call them out as negative.

One metric that is very important in evaluating any post is how many people are unique commentators rather than simply being a single person who seeks to influence those watching the site by creating more apparent volume through repeated postings. Naturally, a single person repeatedly indicating a “like” is far less valuable in targeting likely buyers than an equal number of postings from distinct persons, thus, at a block 213, the metric “Unique Commenters” is presented.

On the flip side, however, it is important to know when a commenter has felt approval deeply enough to desire to comment, “Like”, or repost multiply. This metric is also meaningful in judging the influence that the post promulgates. For that reason, it is separately reported at a block 207.

At a block 216, one exemplary lexical analysis of responses might, for example, yield a ratio between Interrogatives and Declaratives. For purposes of the example, “Interrogatives” describe responsive posts that ask questions while “Declaratives” describe simple statements. In the interpersonal resources, interactive meaning potential is established with speech functions and sentence adjunct. A post which has many declarative sentences which is for blogging as a form of modern storytelling, and it fits well with the thematic structure as an informal medium with focus on real people and their personal opinions.

Other forms of lexical analysis exist and can advantageously be brought to bear within the context of the invention. If exclamations, imperatives or interrogatives were used, a post could perhaps be perceived as too opinionated and not be taken seriously as “news casting.” However, values and opinions are expressed through use of evaluative adjectives in attitudinal lexis, pointing to the speaker's attitude though in a more implicit manner than if done through speech functions.

A blog in the classical sense includes many examples of interpersonal resources. Both exclamative and interrogative speech functions are used alongside the declarative description which signifies an interaction with the reader that classifies the text as a blog within social media and demonstrates how this genre goes beyond the online personal diary. Blogging is a communication tool that emphasizes self-expression and knowledge sharing in an interactive context with focus on creating conversations in an open forum without gatekeepers. Applied to public relations, blogs and social media naturally cause some changes to the dynamic and structure of communication in the information value chain. Because blogs communicate through a two-step flow model with bloggers as opinion leaders, disseminating information in a networked context, the site owner loses the position of control as gatekeeper of organizational information communication.

Relationship management strategies were applied to Google's idea of participating actively in the blogosphere through the Official Google Blog in order to show how blogs are used for the PR purposes of creating and maintaining mutually beneficial relationships. As a result, corporate blogging was determined as a PR function with the purpose of showing the public transparency in organizational communication and providing opportunities for interpersonal conversations online.

Given the differences in response that Interrogative posts generate, for any page, it is very interesting to see which sort of post generates a greater following and with that knowledge discern how the blogging public perceives the product. Thus, where posts responding to an interrogative post cause five times the number of responsive posts as a similarly posted declarative post, the posting public has indicated that they desire a more intimate view of the product by those closer to it than the clinical view of the product that a declarative statement yields. That metric is reported in a block 216.

Similarly, responses that are either declarative or interrogatory tell the site owner something of the nature of the reception that a post has gotten and might steer the optimum selection of the next post. For example, where a posting relating to a new Office™ program, say, Word™, for example speaks of reorganizing the drop down menus in order to achieve greater user efficiency, interrogative postings in response might yield a great deal of information as to what features might be more fully described in a subsequent post. The percentage of interrogative posts generated by the primary post is reported in a block 210.

A block 219 is best understood with reference to FIG. 3 and a graph 250. As is evident, two curves track the actual history of the website, the interactions 258 and the posts 255. These two curves interactions 258 and posts 255 represent trackable visits to the site. Notable is the fact that while the curves do not overlay precisely, they to show an approximately congruent characteristic curve that shows a rapid growth in response followed by an oscillating decay to negligible levels.

Overlaid on the curves showing interactions 258 and posts 255 is a polynomial that approximates these curves. A third degree polynomial is shown having two local maxima. Generally speaking, third degree polynomials are sufficient to show the suitable rise and decay for purposes of explaining the invention but the invention is not limited to only third degree polynomials. The use of the invention will drive the statistical analysis to the most useable for prediction on rise and decay in response to a particular type of post.

Polynomials are particularly useful for dynamically estimating response because in prediction they will generally have the same shape and those coefficients selected to approximate polynomial curve will dictate the height of the predicted response, the duration of the response, and the rate at which it will be decay to zero. As such, very few numbers need be stored in order to well define the curve representing the expected reaction to a given post. As is also evident from the closeness of the approximation, there is sufficient information in a cubic polynomial to allow a poster to suitably “shingle” a web site such that in the absence of unusual influences not suitably accounted for the comments and postings could be nearly continuously kept at a relatively high level of activity by choosing a threshold lever such as 250 so that when the polynomial selected to approximate either curve 255, 258 crosses the 250 level on a downward inflection, the next post is made to, again, excite posters to comment or to interact and to continue to maintain exchanges in excess of that level by suitably timing the further postings.

Given the inherently “smooth” nature of polynomial curves, predicting decay to a threshold value becomes a fairly simple modeling task, easily achievable by conventional analytics. As such, within tolerances that are acceptable for this application, reaching the threshold point can be predicted with certainty.

Further analytics allow associations between characteristic curves defined by discrete coefficients as described above and the content of posts being characterized by voice, mood, nature of posting (declaratory v. interrogatory, as above), perceived demographics of poster and other such qualities. Extensive libraries of associations between characteristic curves and content are developed further through use of the system and the dynamic means of adjusting coefficients to arrive at usable relationships between content and coefficients, thereby allowing analysis of a particular posting for a quality of “heat” defined as the likely receptivity of a populace having demographic qualities who are following a given page. “Heat” may be modified by the timing of external events and their assumed effect upon the demographic but collectively, taking in all factors capable of analysis, “heat” is an expression of likely receptivity as expressed by induced posting activity on a site after the rated post.

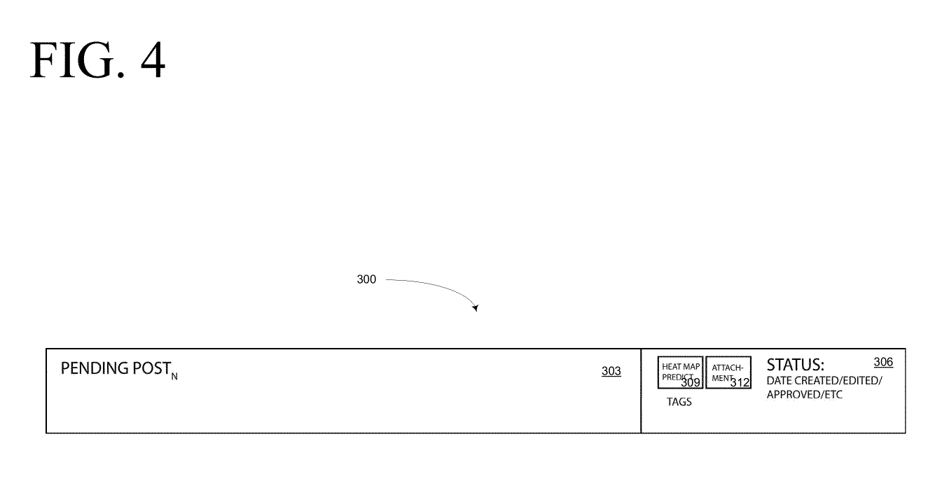

An inventive interface facilitates the timely postings on a page. Referring to FIG. 4, a posting is graphically represented as a tile 300, containing a content block 303 and a status block 306. The status block 306 is accompanied by two further blocks, an attachment block 312 and a heat map block 309 whose color has been selected to reflect of the above-discussed “heat” of the post. Understanding the makeup of the tile 300 readily facilitates its intuitive use.

While the content block 303 contains text that would be a component of the post, the common occurrence of smart phones capable of creating video files and playing all sorts of different types of files causes artificial constraint of confining the postings to strictly test to give the site a dated and less relevant, less vital look when compared with other sites. For this reason, posts can be readily augmented. While postings are largely textual in nature and where not completely so, they are augmented by discrete attachments of a particular MIME-type, for example, video files or musical files to lend vitality to the site. For this reason, the attachment block serves as a button capable of allowing an auditor of the post to see the attachment proposed as part of the nascent post that the tile 300 represents.

Within the status block 306, the tile 300 reflects the current status of a post as to whether it has been approved by an approving authority. If the then-current user is an approving authority, as discussed above, the current user, based upon assigned access privilege can alter the status of the post but regardless of whether the then-current user's access privileges include the right to approve the post, the post is displayed within the tile 300 and bearing its approval status in the block 306. In this manner, the tile 300 complete details the prerelease makeup of the post. With the inventive system, the tile itself is the icon that enables editing, simply by “clicking” on the tile to open a text editor that may also, optionally, allow the attachment of distinct MIME-type attachments. For example, a gallery of suitable MIME-type attachments might optionally reside on the system server described above for rapid attachment onto a post as part of a campaign. In placing the attachments there, the system allows for rapid revisions of the post by several parties in collaboration and through limited platforms such as smartphones.

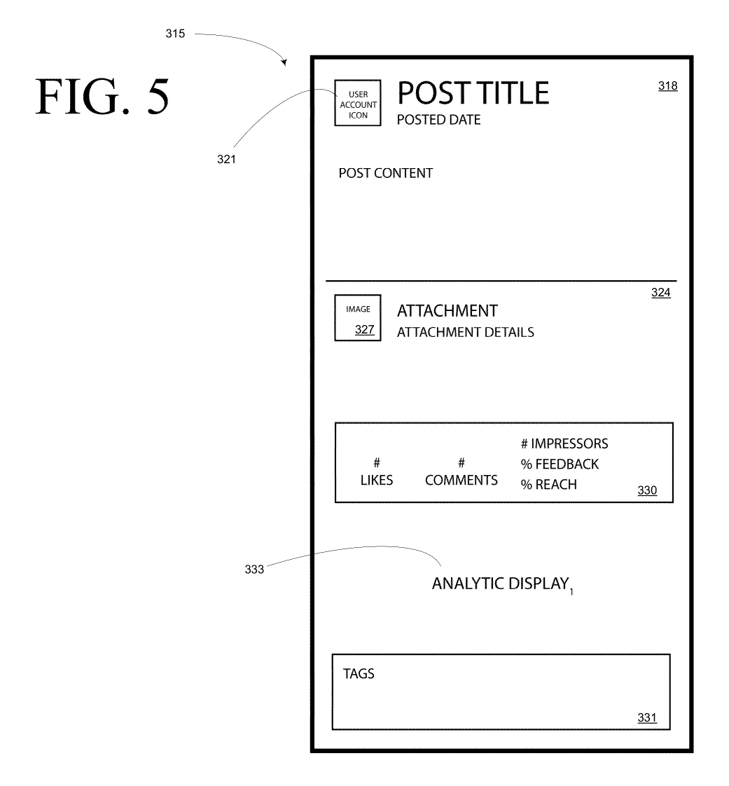

As FIG. 5 conveys, a second tile 315 is immediately generated upon the release of the post and intuitively displays the results from tracking of the observed responses to a released post including dynamic adjustment of the polynomial curve used for modeling the predicted life and response to a given post based upon those responses. This second tile 315 includes a post title block 318 having a user icon 321, the Post Title and posting date and time as well as the final textual content of the post as it appeared on the website.

Additionally, the second tile includes the attachment icon 327 as well as the attachment title and a resume of details at a block 324.

At a block 330, the raw data and near-raw data generated from the release of the post is conveyed, especially as to several key metrics. “Comments”, “Likes” and “Impressors” are self-explanatory titles for the raw observed data in interaction with the post on the website. Simple quotients then define the “feedback” as the number of persons who have submitted feedback as well the “reach” of the post.

At a block 333, an analytic display 250 (FIG. 3) is displayed to give a graphic rendition of the anticipated rise and decay of activity that the post engenders. This is a dynamic display in that the polynomial approximation of the decay curve is changed as more data accumulates. Having the graphic analytic display 250 within the second tile 315 assures that any then-current user is able to readily estimate when the optimal moment might be to inject another post to assure

Also within the preferred embodiment of the inventive interface, a block 331 includes an opportunity to tag the post with tags that are likely to attract attention for those who might use search engines as their main means to locate sites of interest to them. In one embodiment, lexical analysis provides suggested tags for the post based upon context and the hosting site. These, however, would be suggested tags, allowing the manager of the site to review them and to modify them before or even after posting the post.

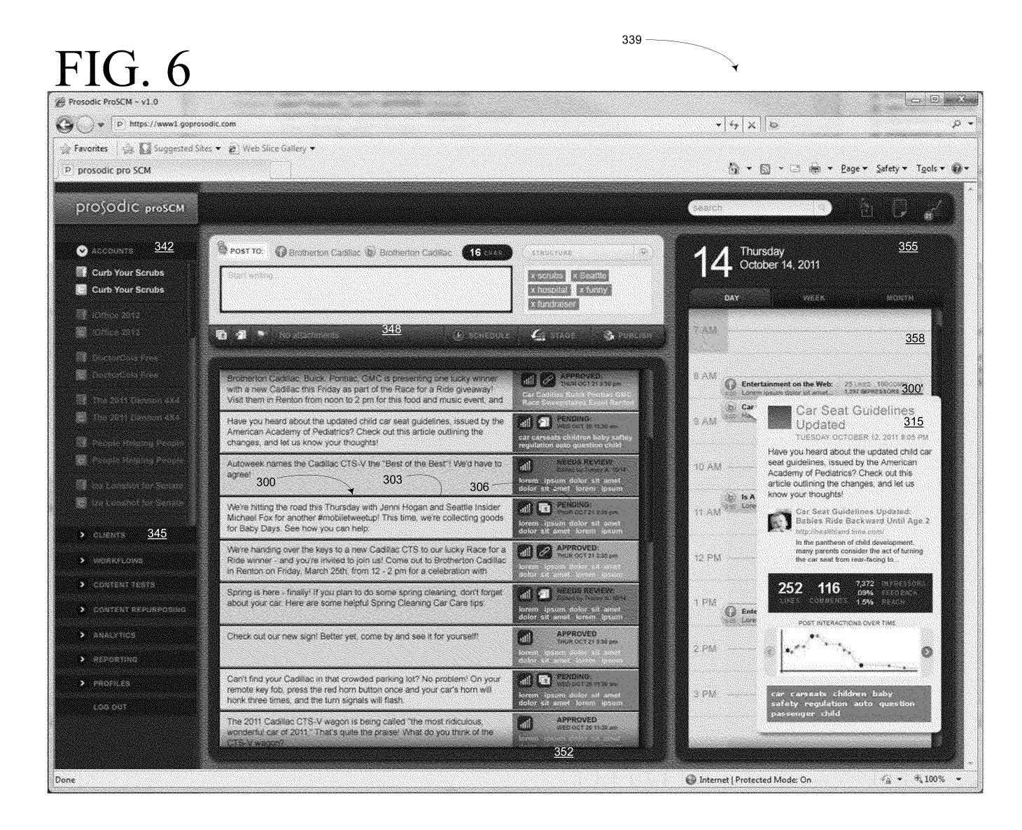

To better understand the workings of the interface, in FIG. 6, an exemplary web-based client interface of the presently preferred embodiment is shown with the above-described first graphic tile 300 having blocks 303 and 306 as described above with reference to FIG. 4, is shown in a rolling scroll in a derivation of an interface known as a Spinning Wheel interface. The second graphic tile 315 is also shown in the context of a calendar interface configured as a Spinning Wheel as well.

The preferred embodiment is the “Spinning Wheel” interface, also known as a slot machine interface The Spinning Wheel tool provides a fast and flexible user interface for many kinds of data input and visualization. It allows multiple columns or slots to be defined to represent complex values like dates and other tabular data. In this embodiment, two distinct single column spinning wheels are used. In contrast to a traditional selection environment for a typical social-networking application, a user here is presented with a simple column of first tiles 300, each fixed tile having a first block 300 and a second block 303, but the one-to-one fixed relation of these blocks 303, 306 causes the tile 300 to be a single face on the spinning wheel rather than to allow the interface to “mix and match” among the first and second blocks 303, 306. As is shown on display segment or window 352 of a portable computing device or, in fact, any platform with browsing or client capability, the column of tiles is dragged across the window for display by either a pointing device such as a mouse or by user movement of fingers across a touch-sensitive display. User then taps the entry that he or she wishes to view. In response to this user tap, the system shifts the display focus from the window 352 to the tile 300 to be either edited for content, selected for posting, or otherwise to isolate the operation of the system to treatment of the tile 300 rather than scrolling the entirety of the column of tiles.

Embodiments of the present invention might, optionally, include, during operation, receiving an indication that the portable computing device has been rotated and shifting the display orientation accordingly. Consider the example where portable computing device initial orientation is generally horizontal. In response to a user rotating the portable computing device to a generally vertical orientation the display presentation mechanism presents user with a distinct arrangement of the elements on display to enhance the use in the new orientation. Also, then, in some embodiments of the present invention, the content is stacked along a simulated Z-axis, which user can navigate by moving his or her finger along a vector collinear to the simulated Z-axis.

In a similar manner, a calendar display 355 is present. In this exemplary calendar, the tabular data is 30 minute time slots which might be either empty slots or might be slots occupied by posts. As with the column of tiles in the window 352, the calendar window 358, in this exemplary embodiment, will scroll upward and downward in response to a pointing device, as the focus of the display will also shift in response to “clicking ” So, in this embodiment, as one scrolls down (or up) the calendar page in the window 358, abbreviated versions 300′ of the tile 300 appear in the slots in the calendar window 358, as place holders. Where the placeholder abbreviated version is a past event, changing to focus on the abbreviated version 300′ causes the tracking tile 315 to appear in the window showing the performance of the posted post.

In some embodiments of the present invention, activation within the window 355, allows a sorting mechanism to alter the display from a calendar view to an alternate sort of the abbreviated versions 300′ of the tiles. Depending on the desired implementation, the detailed list of items can be sorted by one of: a time related to the items (calendar view), an author of the items, a subject of the items, or a type of the items. Note that as described previously, options related to sorting criteria can be configurable by user or by a system administrator. In any regard, in the presently preferred embodiment, the calendar view is the preferred view of the second window 358.

Likewise, the first window 352 is also sortable. Depending on the desired implementation, the detailed list of items can be sorted by one of: a time related to the items (calendar view), an author of the items, a subject of the items, or a type of the items, as well as by “heat”, client, attachment, or, status as approved, pending, needing review, etc. With regard to either window 352, 358, the purpose of the sorting is to enhance and amplify the efforts of the user in an intuitive interface.

In some embodiments of the present invention, presentation mechanism window 352, 358 displays a scrollbar beside the detailed list of items. The system also displays on the scrollbar a position of an item of content that has the focus, as is indicated by selection indicator 405. Furthermore, the system may indicate on the scrollbar a selected window 352, 358, which indicates the range of all of the items visible on either segment of the display at the current time.

Additionally, in the presently preferred embodiment, links exist to navigate into distinct windows that modify the display to filter only those tiles 300 relevant to a single website 342, or to change move to a display of any of “clients,” “workflows,” “Content tests” (e.g. lexical, voice, or semantic tests), “Content Repurposing,” “Analytics”, “Reporting,” or “Profiles.” By these links, the intuitive nature of the interface is exploited to facilitate the use of the server by means of any suitable client on any appropriate platform, including those with limited display capability or area such as a smart phone.

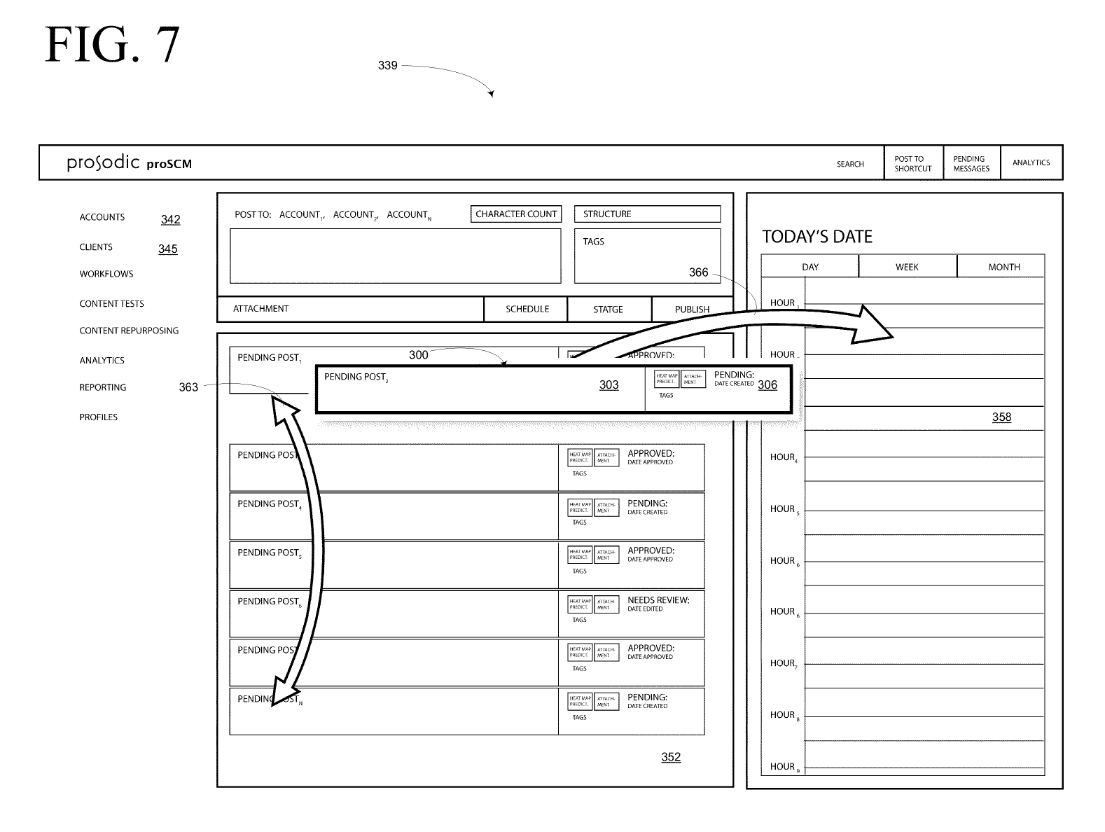

In FIG. 7, the client interface 339 is show in a “wire frame” line drawing to demonstrate the simplicity of the use of the client application. In particular, this FIG. 7 is included to show two independent and distinct movements 363, 366 exploiting the interface 339, exploiting the first and second windows 352, 358 and the placement of tiles 300 thereon. The navigational links 342, 345 are included for completeness but do not figure in two distinct movements 363, 366.

While the system performs a number of sorts autonomously, as described above, a user often has distinct criteria for sorting that do not apply system-wide. Consider the exemplary situation where a client anticipates the roll-out of a new product to meet a perceived need in the marketplace; there, a particular post carry a priority for release that cannot be based simply on the predefined sort regimens set forth in conjunction with FIG. 6. By an earlier described change of focus to the tile 300, the user can “drag and drop” the tile 300, representing a pending post, from a first position to a second position 363 to order the tiles 300 in accord with a user-defined sequence. Repeated movements will allow the user to sort all of the tiles 300.

In a distinct, but useful movement, actual scheduling of posts can readily be accomplished by interaction with the interface 339. In a second “drag and drop” movement 366, the user draws the tile 300 to the calendar view 358 to place the tile in a particular time slot on the calendar view.

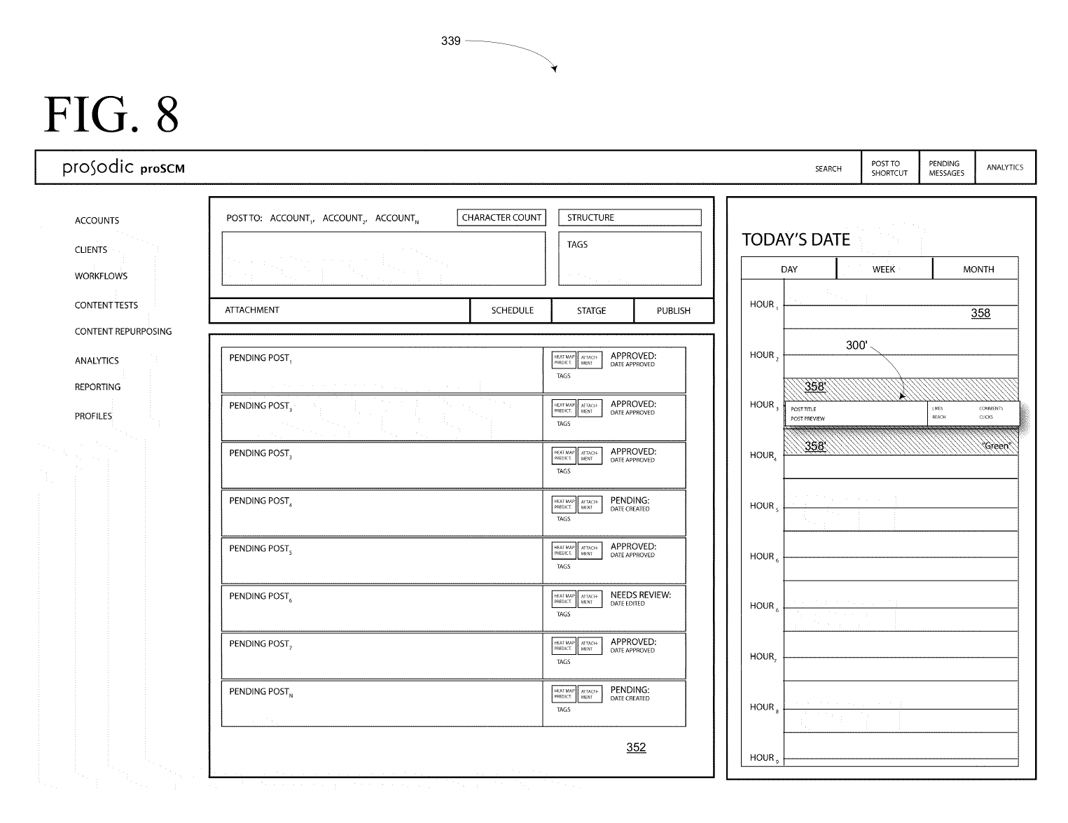

FIG. 8 demonstrates the interface 339 immediately after the scheduling movement 336 (FIG. 7). Upon “dropping”, the abbreviated tile 300′ is shown in the receiving slot on the calendar window 358.

In a presently preferred embodiment, the heat map is exploited to assure that placement of a post will be suitably effective. As explained above with reference to the analytics the heat map exploits, a color is used to indicate the determined heat of a particular posting on the calendar. When “hovering” before placement by dropping such as described with reference to FIG. 8, the immediately adjacent time slots will display the “heat” associated with placement in the designated time slot as a color 358 (in this exemplary case, green). The duration of the display of the green color 358′ is a configurable variable in the exemplary embodiment.

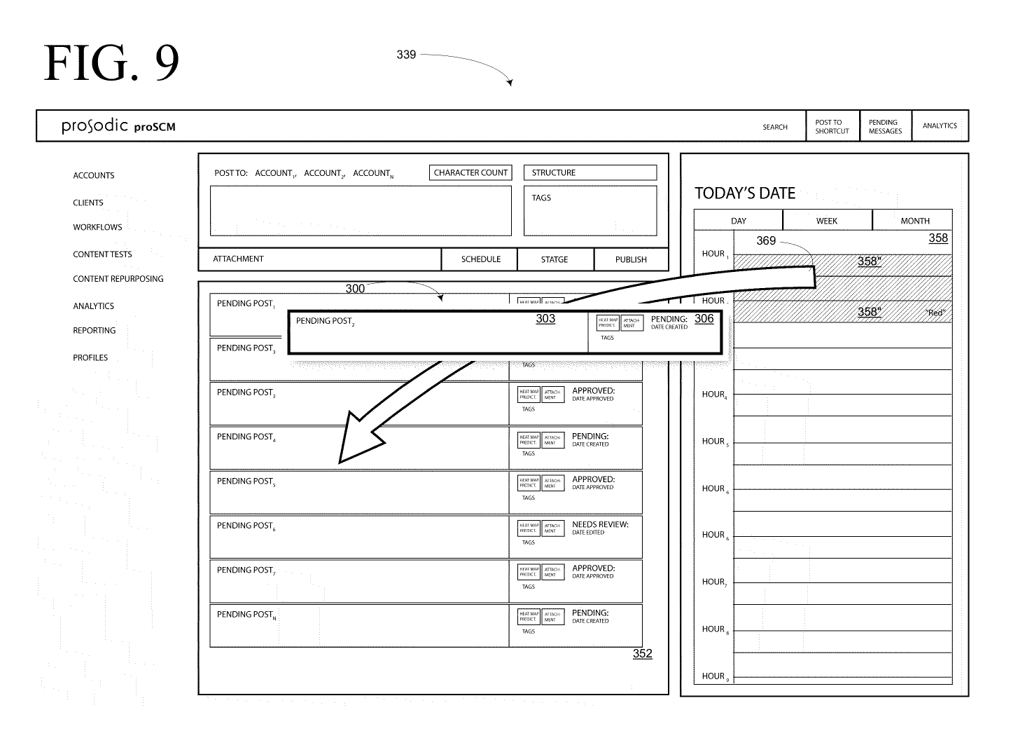

FIG. 9 demonstrates the converse movement of a proposed post from the calendar window 358, where it is currently scheduled to the group of nascent posts visible in the window 352, having the effect of de-scheduling the post. Again, as in the above described preferred embodiment, hovering over the scheduled slot causes the color the heat map associates with the desirability of placement in the slot, In this manner, hovering over the tile 300, in its abbreviated form causes the two adjacent slots to display red 358 indicating that the placement of the post in that slot is no longer desirable. With a similar “drag and drop” movement 369, the user draws the tile 300 from the calendar window 358 to the nascent post window 352 for later placement in a different slot. In this manner, the scheduling and descheduling of nascent posts is readily accomplished with minimal movement on diverse platforms in the presently preferred embodiment.

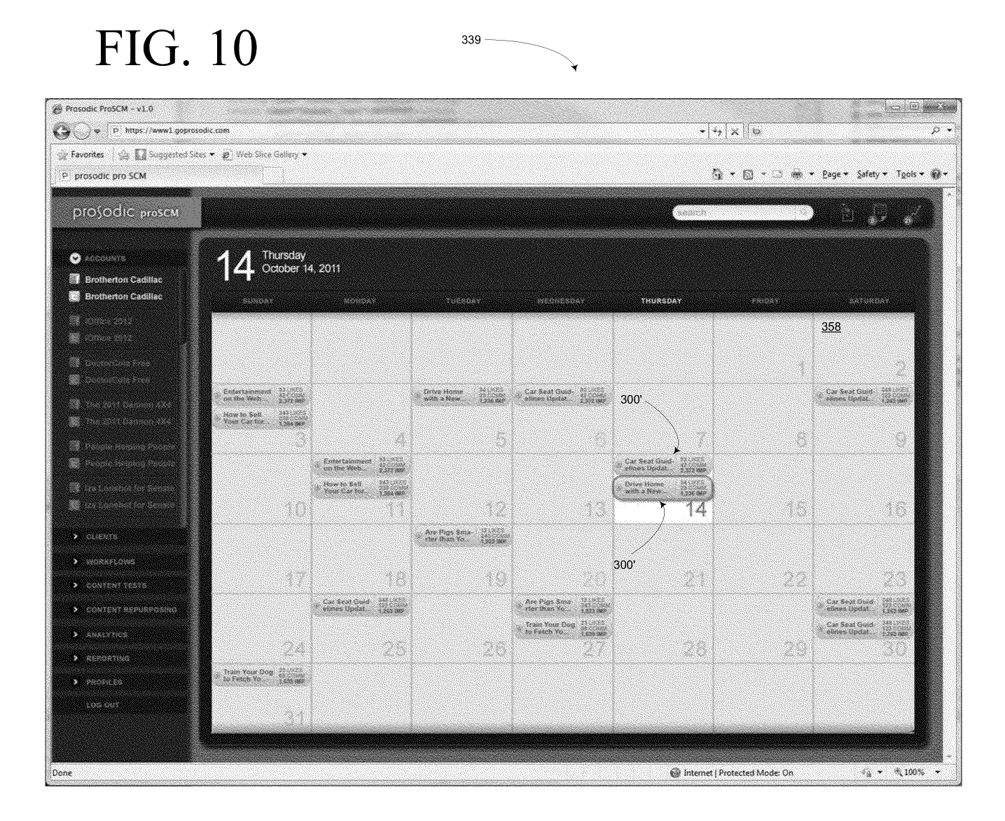

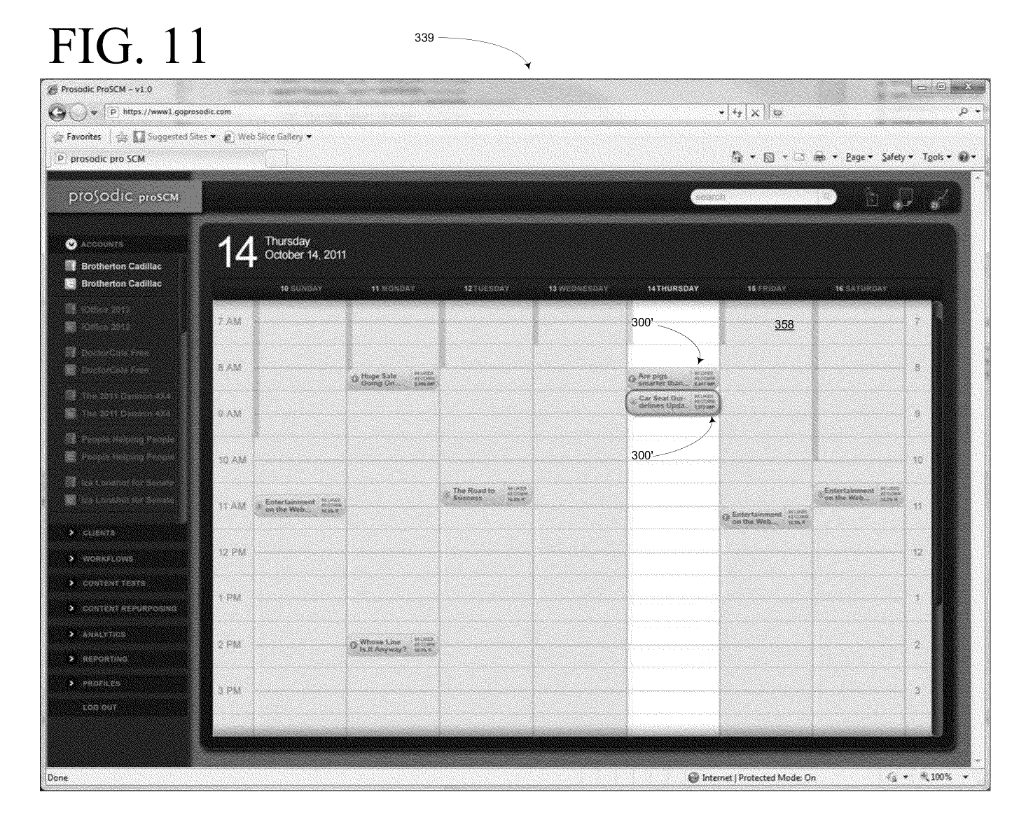

FIGS. 10 and 11 demonstrate the ability to shift to both of a “month view” (FIG. 10) and a “week view” (FIG. 11), as a user's immediate needs dictate. In the presently preferred embodiment, the dynamic scheduling is used in the “day view” mode (See FIGS. 6-9) but there is nothing inherent that requires that the interface 339 is so limited. The current preference, however, allows for a less busy display while assuring optimal ability to exploit the interface 339 on even the smallest of screens.

While the preferred embodiment of the invention has been illustrated and described, as noted above, many changes can be made without departing from the spirit and scope of the invention. Note, for example, that the embodiments disclosed herein refer to a social-networking application for exemplary purposes. However, embodiments of the present invention are not meant to be limited to social-networking applications.

For example, using the interface 339 in “week view” for scheduling posts. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A computer implemented method for composing and posting content at a site on a wide area network
receiving content for a nascent post at a composer/editor component of a computer system;
displaying the content retrieved from the composer/editor component at a display component, the content displayed as a graphic tile, the graphic tile including one of the following:
a text block displaying a portion of textual content within the nascent post;
an identifier for the nascent post;
a status block displaying a status of review where the nascent post must be reviewed for release by at least one reviewing authority; and
a block indicating the presence and identity of a MIME-type attachment within the nascent post;
displaying, at the display component, a calendar window including a plurality of time slots corresponding to each of a plurality of posting times of the nascent post on the site;
scheduling, at a publisher component, the posting time of the nascent post on the site, the posting time designated by “dragging and dropping” the graphic tile onto one of the plurality time slots.

2. The method of claim 1, wherein:
the calendar window includes a region that is colored to indicate the efficacy of the nascent post if posted at a time the time slot represents.

3. The method of claim 2, wherein the region includes time slots adjacent to the time slot dedicated to the time.

4. The method of claim 2, wherein the region is a color selected from a spectrum wherein the position within the spectrum corresponds to a magnitude of an efficacy coefficient selected to reflect efficacy of the post.

5. The method of claim 1, wherein:
the graphic tile includes
the text block displaying the portion of textual content within a nascent post; and
the status block displaying a status of review where the nascent post must be reviewed for release by at least one reviewing authority; and
the reviewing authority can change the status of review to indicate a nascent post is released to be posted by interaction with the graphic tile so long as the reviewing authority has sufficient rights to change the status.

6. The method of claim 5, wherein the reviewing authority can, using a composer/editor component perform a task selected from the action group consisting of:
editing the textual content;
selecting a MIME-type attachment for inclusion within the nascent post;
removing a MIME-type attachment for inclusion from the nascent post;
changing the apparent authorship of a nascent post.

7. The method of claim 1, wherein the scheduling of the posting of a nascent post includes, at a posting time, the automatic writing of the nascent post onto the site the posting time based upon the graphic tile's occupying the time slot.

8. A system for composing and posting content at a site on a wide area network a composer/editor component of a computer system to receive content for a nascent post;
a display component for displaying the content retrieved from the composer/editor component at, the content displayed as a graphic tile, the graphic tile including one of the following:
a text block displaying a portion of textual content within the nascent post;
an identifier for the nascent post; and
a block indicating the presence and identity of a MIME-type attachment within the nascent post;
the display component being further configured to display a calendar window including a plurality of time slots corresponding to each of a plurality of posting times of the nascent post on the site;
a publisher component for scheduling the posting time of the nascent post on the site, the posting time designated by “dragging and dropping” the graphic tile onto one of the plurality time slots.

9. The system of claim 8, wherein:
the calendar window includes a region that is colored to indicate the efficacy of the nascent post if posted at a time the time slot represents.

10. The system of claim 9, wherein the region includes time slots adjacent to the time slot dedicated to the time.

11. The system of claim 9, wherein the region is a color selected from a spectrum wherein the position within the spectrum corresponds to a magnitude of an efficacy coefficient selected to reflect efficacy of the post.

12. The system of claim 8, wherein the display component for displaying the content retrieved from the composer/editor component further comprises:
a status block displaying a status of review where the nascent post must be reviewed for release by at least one reviewing authority;

13. The system of claim 12, wherein:
the graphic tile includes
the text block displaying the portion of textual content within a nascent post; and
the status block displaying a status of review where the nascent post must be reviewed for release by at least one reviewing authority; and
the reviewing authority can change the status of review to indicate a nascent post is released to be posted by interaction with the graphic tile so long as the reviewing authority has sufficient rights to change the status.

14. The system of claim 13, wherein the reviewing authority can perform a task selected from an action group consisting of:
editing the textual content;
selecting a MIME-type attachment for inclusion within the nascent post;
removing a MIME-type attachment for inclusion from the nascent post;
changing the apparent authorship of a nascent post.

15. The system of claim 8, wherein the scheduling of the posting of a nascent post includes, at a posting time, the automatic writing of the nascent post onto the site the posting time based upon the graphic tile's occupying the time slot.

16. A method, implemented by a computing device configured to perform the following, comprising:
accessing a first time slot in a calendar window, wherein the first time slot comprises an associated posting time for the automatic for writing of a nascent post onto a web site;
determining content of the nascent post based upon a graphic tile; and
at the posting time, writing the content of the nascent post onto the web site.

17. The method of claim 16, wherein the graphic tile includes at least one element selected from a group comprising:
a text block displaying a portion of textual content within the nascent post;
an identifier for the nascent post;
a status block displaying a status of review where the nascent post must be reviewed for release by at least one reviewing authority; and
a block indicating the presence and identity of a MIME-type attachment within the nascent post.

18. The method of claim 16 further comprising editing at a composer/editor component of the computer, an action selected from the group consisting of:
editing the content of the nascent post from an action group consisting of:
editing the textual content;
selecting a MIME-type attachment for inclusion within the nascent post;
removing a MIME-type attachment for inclusion from the nascent post;
changing the apparent authorship of a nascent post.

19. The method of claim 16 further comprising dynamically changing the posting time for the automatic for writing of a nascent post onto a web site by “dragging and dropping” the graphic tile from the first time slot to a second time slot in the calendar window.

20. The method of claim 19, wherein
the calendar window includes a region that is colored to indicate the efficacy of the nascent post if posted at a time the second time slot represents.

21. The method of claim 16 further comprising:
accessing, by a reviewing authority, the graphic tile at the composer/editor component based upon an access control protocol;
amending the status block to indicate the reviewing authority has approved the nascent post for automatic posting; and
wherein writing content is writing the content where the status block indicates the reviewing authority has approved the nascent post for automatic posting.
